(19) United States
(12) Patent Application Publication
(10) Pub. No.: US 2026/0040184 A1
(43) Pub. Date: Feb. 5, 2026

(54) APPARATUS AND METHOD FOR USER TRAFFIC CONTROL BASED ON REQUEST OF APPLICATION SERVICE FUNCTION IN WIRELESS COMMUNICATION SYSTEM

(71) Applicant: ELECTRONICS AND TELECOMMUNICATIONS RESEARCH INSTITUTE, Daejeon (KR)

(72) Inventors: Changki KIM, Daejeon (KR); Jeoung Lak HA, Daejeon (KR); Tae Yeon KIM, Daejeon (KR)

(73) Assignee: ELECTRONICS AND TELECOMMUNICATIONS RESEARCH INSTITUTE, Daejeon (KR)

(21) Appl. No.: 19/271,449

(22) Filed: Jul. 16, 2025

(30) Foreign Application Priority Data
Aug. 1, 2024 (KR) 10-2024-0102668
Aug. 2, 2024 (KR) 10-2024-0103224
Nov. 7, 2024 (KR) 10-2024-0156763
Nov. 21, 2024 (KR) 10-2024-0166791
Jun. 27, 2025 (KR) 10-2025-0085563

(51) Int. Cl. H04W 40/02; H04L 69/22

(52) U.S. Cl. CPC H04W 40/02; H04L 69/22

(57) ABSTRACT

A wireless communication system provides header handling control for user traffic based on Application Function (AF) requests. A Network Exposure Function (NEF) receives traffic header handling control information from an AF and transmits it to a Session Management Function (SMF) via a Policy Control Function (PCF). The SMF generates header handling control rules based on the received information and sends them to a User Plane Function (UPF) through an N4 interface. The UPF processes user traffic header handling according to the rules, performing operations including header detection, removal, replacement, and insertion. Processing results are transmitted directly to the SMF, NEF, and/or AF through a Nupf_EventExposure service interface. The system enables flexible user traffic header control and efficient event reporting with reduced signaling overhead.

### CROSS REFERENCE TO RELATED APPLICATION

This application claims priority to Korean Patent Application No. 10-2024-0102668, filed on Aug. 1, 2024, Korean Patent Application No. 10-2024-0103224, filed on Aug. 2, 2024, Korean Patent Application No. 10-2024-0156763, filed on Nov. 7, 2024, Korean Patent Application No. 10-2024-0166791, filed on Nov. 21, 2024, and Korean Patent Application No. 10-2025-0085563, filed on Jun. 27, 2025, the entire contents of which are hereby incorporated by reference.

### BACKGROUND OF THE INVENTION

### Field of the Invention

The present disclosure relates generally to wireless communication systems, and more specifically to an apparatus and method for header handling control of user traffic based on requests from an Application Function (AF) in wireless communication systems.

### Description of the Related Art

Fifth Generation mobile communication systems (5G System, 5GS) have been developed to provide enhanced data transmission rates, low latency, and massive device connectivity compared to existing fourth generation mobile communication systems. 5GS has significantly improved network flexibility and scalability by configuring network functions as a microservice-based Service Based Architecture (SBA).

The 3rd Generation Partnership Project (3GPP) began defining the basic architecture of 5GS from Release 15, and Release 16 added functions to support industrial IoT and Ultra-Reliable Low Latency Communication (URLLC) services. Release 17 enhanced network slicing and edge computing functions, and Release 18 introduced improved User Plane Function (UPF) capabilities.

Particularly in Release 18, UPF Event Exposure functionality and Service Based Architecture integration began. This established the foundation for Application Functions (AF) to access information within the network and influence network operations through the Network Exposure Function (NEF). In Release 19, UPF functionality is being further enhanced through UPEAS (UPF enhancement for Exposure and SBA) standardization work.

Traditionally, user traffic control in mobile communication networks has primarily focused on packet routing and Quality of Service (QoS) management. Network operators managed traffic flows per user session through Policy Control Function (PCF) and Session Management Function (SMF), and applied actual packet forwarding and QoS policies at the UPF. Existing Service Function Chain (SFC) approaches focused on forwarding traffic to function nodes that provide corresponding network services according to rules to provide various network services to specific user traffic.

However, as application service requirements have become more complex and network virtualization and Software Defined Networking (SDN) technologies have advanced, the need for more detailed and dynamic traffic control methods has increased. Application service providers particularly require methods to optimize network resources according to their service requirements and process user traffic more precisely.

Conventional user traffic control methods primarily relied on forwarding rules based on basic header information such as packet destination addresses and port numbers. While this approach was suitable for simple routing and QoS application, it had limitations in meeting complex application service requirements. Additionally, existing methods have problems including: difficulty meeting diverse application service requirements due to limited traffic processing capabilities; limited interworking between application service providers and network operators; and difficulty responding to dynamic service requirements due to static policy-based traffic control.

### SUMMARY OF THE INVENTION

Based on the above discussion, the present disclosure provides an apparatus and method for defining traffic header handling control information that an Application Function (AF) provides to a Network Exposure Function (NEF) for AF to perform header handling of user traffic in wireless communication systems. The present disclosure also provides an apparatus and method for defining N4 rules containing traffic header handling control rules transmitted between Session Management Function (SMF) and User Plane Function (UPF) in wireless communication systems. Furthermore, the present disclosure provides an apparatus and method for UPF user traffic header handling processing and reporting methods for handling processing results in wireless communication systems.

According to various embodiments of the present disclosure, an event processing method for header handling of user traffic based on application request in a wireless communication system comprises: a Network Exposure Function (NEF) receiving traffic header handling control information from an Application Function (AF) and transmitting the traffic header handling control information to a Session Management Function (SMF) via a Policy Control Function (PCF); the SMF generating a traffic header handling control rule based on the traffic header handling control information received from the PCF through a Service Based Interface (SBI) and transmitting it to a User Plane Function (UPF) through an N4 interface; and the UPF processing traffic handling with the header handling control rule received from the SMF and directly transmitting the handling processing results to one or more of the SMF, NEF, or AF through a Nupf_EventExposure service interface.

According to various embodiments of the present disclosure, an operation method of a User Plane Function (UPF) performing header handling in a wireless communication system comprises: receiving a header handling control rule from a Session Management Function (SMF) through an N4 interface; performing one or more header handling operations of header detection, header removal, header replacement, and header insertion on user traffic according to the header handling control rule; and transmitting processing results of the header handling operations to one or more of the SMF, a Network Exposure Function (NEF), or an Application Function

(AF) through a Nupf_EventExposure service interface.

According to embodiments various of the present disclosure, a User Plane Function (UPF) performing header handling in a wireless communication system comprises a transceiver and a processor operatively connected to the transceiver. The processor is configured to: receive a header handling control rule from a Session Management Function (SMF) through an N4 interface; perform one or more header handling operations of header detection, header removal, header replacement, and header insertion on user traffic according to the traffic header handling control rule; and transmit processing results of the header handling operations to one or more of the SMF, a Network Exposure Function (NEF), or an Application Function (AF) through a Nupf_EventExposure service interface.

The apparatus and method according to various embodiments of the present disclosure enable flexible control of user traffic headers by systematically providing header handling control information from AF to UPF.

Additionally, the apparatus and method according to various embodiments of the present disclosure provide an efficient reporting mechanism for header handling processing results, enabling accurate event monitoring while reducing signaling overhead.

The effects obtainable from the present disclosure are not limited to the effects mentioned above, and other effects not mentioned will be clearly understood by those of ordinary skill in the technical field to which the present disclosure belongs from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a 3GPP 5G system architecture where a 5G User Plane Function (UPF) is included in a service-based structure according to various embodiments of the present disclosure.

FIG. 2 illustrates a signaling procedure for providing conventional 5GS SFC functionality according to various embodiments of the present disclosure.

FIG. 3 is an information element of an AF Request containing Header Handling Control Information transmitted between AF and NEF according to an embodiment of the present invention.

FIG. 4 is an N4 FAR (Forwarding Action Rule) containing a Header Handling Control Rule according to an embodiment of the present invention.

FIG. 5 is a signaling procedure for user traffic header handling according to an embodiment of the present invention.

FIG. 6 is a flowchart of an event processing method for header handling of user traffic based on requests from application in a wireless communication system according to an embodiment of the present disclosure.

FIG. 7 is a flowchart of a method for performing header handling in UPF according to an embodiment of the present disclosure.

FIG. 8 illustrates the configuration of a network entity in a wireless communication system according to various embodiments of the present disclosure.

### DETAILED DESCRIPTION OF THE INVENTION

Terms used in the present disclosure are used only to describe specific embodiments and may not be intended to limit the scope of other embodiments. Singular expressions may include plural expressions unless the context clearly indicates otherwise. Terms used herein, including technical or scientific terms, may have the same meaning as commonly understood by those of ordinary skill in the technical field described in the present disclosure. Among terms used in the present disclosure, terms defined in general dictionaries may be interpreted with meanings identical or similar to meanings in the context of related technology, and unless clearly defined in the present disclosure, they are not interpreted with ideal or excessively formal meanings. In some cases, even terms defined in the present disclosure cannot be interpreted to exclude embodiments of the present disclosure.

Various embodiments of the present disclosure described below illustrate hardware-based approaches as examples. However, since various embodiments of the present disclosure include technologies using both hardware and software, various embodiments of the present disclosure do not exclude software-based approaches.

Additionally, in the detailed description and claims of the present disclosure, “at least one of A, B, and C” may mean “only A,” “only B,” “only C,” or “any combination of A, B, and C.” Also, “at least one of A, B, or C” or “at least one of A, B, and/or C” may mean “at least one of A, B, and C.”

The present disclosure relates to an apparatus and method for user traffic control based on application service requests in wireless communication systems. Specifically, the present disclosure describes technology for systematically controlling header handling of user traffic based on requests from Application Functions (AF) in wireless communication systems and efficiently reporting processing results.

Specifically, 3GPP SA2, a major organization for mobile communication standardization, sequentially began Rel-19 studies from October 2023 and completed Stage 2 Normative standard specifications by December 2024. Since then, standard specifications are currently being updated through maintenance phases.

SA2 is enhancing standards related to SBA-based UPF (User Plane Function) Event Exposure service provision that began from Rel-18 through Rel-19 UPEAS (UPF enhancement for Exposure and SBA) standardization phase 2 work.

One of the currently ongoing UPEAS standardization issue items is enhancing UPF functionality so that Application Functions (AF) can provide user traffic control information to UPF (User Plane Function) to flexibly handle user traffic headers, enabling application service providers or operators to control UPF user traffic in desired forms.

The present disclosure relates to control procedures and methods for AF to handle headers of UPF user traffic. More specifically, it relates to control information that AF provides to UPF, methods for providing this to UPF, and reporting of processing results.

Terms referring to signals, terms referring to channels, terms referring to control information, terms referring to network entities, and terms referring to device components used in the following description are exemplified for convenience of explanation. Therefore, the present disclosure is not limited to the terms described below, and other terms having equivalent technical meanings may be used.

Additionally, the present disclosure describes various embodiments using terms used in some communication standards (e.g., 3rd Generation Partnership Project (3GPP)), but this is only an example for explanation. Various embodiments of the present disclosure can be easily modified and applied to other communication systems.

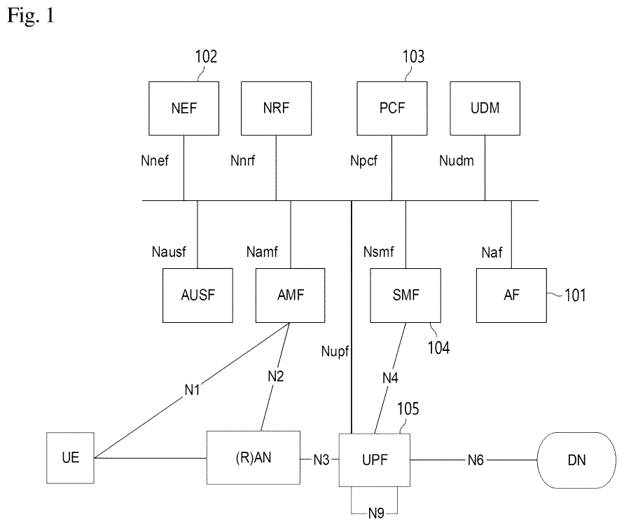

FIG. 1 is a 3GPP 5G system architecture where a 5G User

Plane Function (UPF) is included in a Service-Based Architecture (SBA) according to various embodiments of the present disclosure. Referring to FIG. 1, the UPF is included in the control plane SBA connected with an Service Based Interface (SBI) called Nupf, in addition to the N4 interface with SMF.

The main network functions of the 5G system architecture shown in FIG. 1 are as follows. Application Function (AF) 101 provides an interface between external application services and the 5G network and serves to deliver application service requirements to the 5G network. Network Exposure Function (NEF) 102 provides exposure functionality for secure information exchange between external applications and the 5G network. Policy Control Function (PCF) 103 is responsible for network decision and control, managing Quality of Service (QoS) policies and charging policies. Session Management Function (SMF) 104 manages creation, modification, and release of user sessions and controls the operation of UPF 105. User Plane Function (UPF) 105 is responsible for actual user data processing, routing, and forwarding. Additionally, UPF can interwork directly with other network functions in the control plane through the Nupf SBI interface, in addition to interworking with SMF 104 through the existing N4 interface.

In 5GS, standardization for Service Function Chain (SFC) was conducted in Rel-18 to provide various network services (e.g., virtualization, overlay, orchestration, etc.) to user traffic based on Service Level Agreements (SLA) between application service providers and operators.

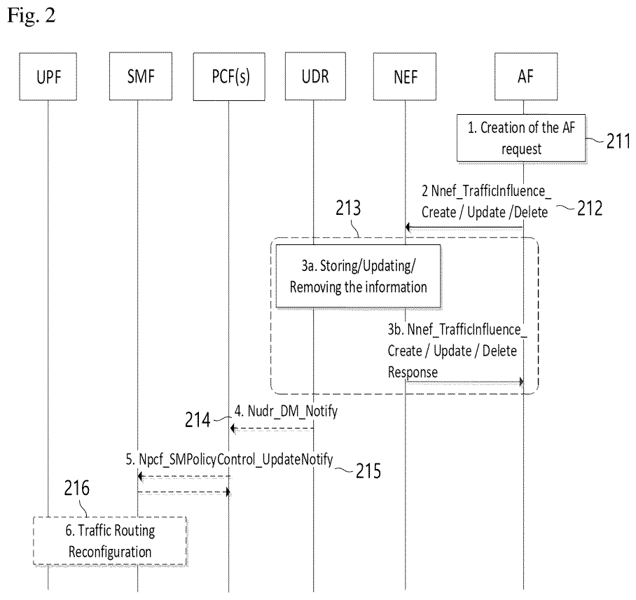

FIG. 2 illustrates a signaling procedure for providing conventional 5GS SFC functionality according to various embodiments of the present disclosure. AF desiring network service functionality delivers traffic control information for SFC to UPF through multiple control function nodes: NEF, UDR, PCF, and SMF (Steps 1-6).

In Step 1 (211), AF generates an AF request for SFC. In Step 2 (212), AF sends a Nnef_TrafficInfluence_Create/Update/Delete request to NEF. The traffic control information for SFC that AF initially delivers to NEF is detailed in TS 23.501 V19.0.0 (2024-06) section 5.6.16.

In Steps 3a and 3b (213), NEF stores/updates/removes received information in UDR, and NEF responds to AF. In Step 4 (214), UDR notifies PCF about AF requirement modifications previously subscribed by PCF. In Step 5 (215), PCF determines policy and sends Npcf_SMPolicyControl_UpdateNotify to SMF.

In Step 6 (216), SMF generates N4 FAR (Forwarding Action Rule) based on policy information received from PCF and sends it to UPF. Subsequently, UPF performs traffic routing reconfiguration applying predefined service function chains to user traffic according to traffic control information received from SMF.

The N4 FAR applied between SMF and UPF is detailed in TS 23.501 V19.0.0 (2024-06) Section 5.8.5.6, and includes ‘Forwarding policy’ and ‘Metadata’ attributes for providing SFC services.

Detailed procedures of FIG. 2 are described in detail in TS 23.502 V19.0.0 (2024-06) Section 4.3.6.2.

Conventional application requested user traffic control focuses on forwarding user traffic to function nodes that provide corresponding network services according to rules to provide various network services to specific user traffic, with corresponding service provision handled by network service providers.

However, SA2 Rel-19 has advanced UPF functionality enhancement through UPEAS (UPF enhancement for Exposure and SBA) standardization work, and as part of this, standardization is underway to expand user traffic control not only for forwarding but also for more diverse handling. More specifically, Stage 2 standardization for header handling functionality is currently underway, which applies rules for detection, insertion, removal, and replacement of specific headers to user traffic, in addition to detection of user traffic headers.

Therefore, the present disclosure proposes a method to provide various services to operators and users by expanding user traffic control by adding control processing procedures for user traffic header handling to existing user traffic control methods in wireless communication systems. Specifically, it provides header handling information that AF provides to NEF for AF to handle user traffic headers, N4 rules containing header handling control rules transmitted between SMF and UPF, and UPF user traffic header handling processing and reporting methods for handling processing results.

For this purpose, AF must provide header handling information to UPF that processes user traffic header handling. First, AF provides control information to SMF through NEF, UDR, and PCF, and with this, SMF generates rules for user traffic header handling and then performs Indirect UPF event subscription to UPF including the generated rules through the N4 interface. The present disclosure enables UPF to process user traffic header handling and directly report results by adding header handling control rules that SMF creates based on user traffic header handling control information provided by AF to the N4 interface. This allows operators and application service providers to control user traffic headers more flexibly.

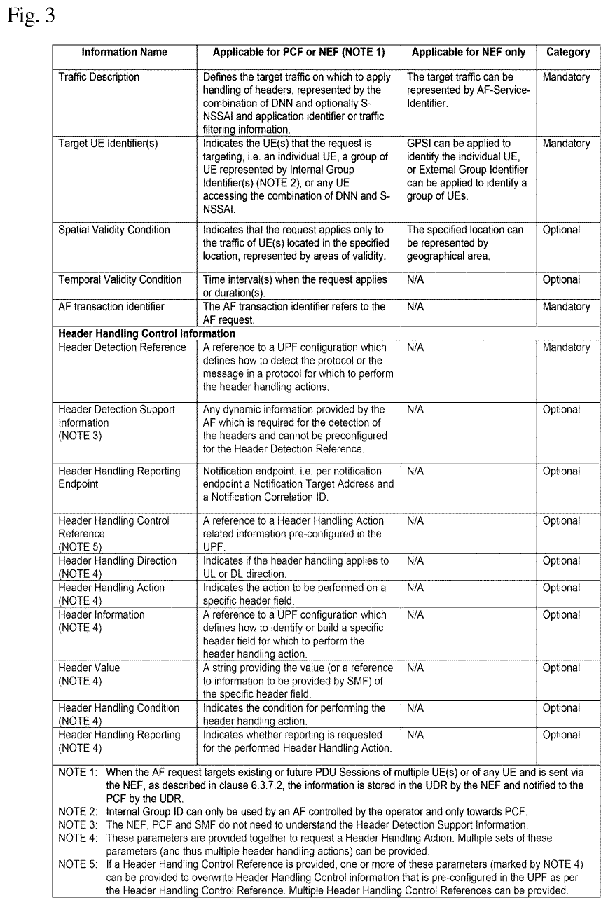

FIG. 3 is an information element of an AF Request containing Header Handling Control Information transmitted between AF and NEF according to an embodiment of the present invention. The header handling control information consists of several detailed information elements.

Header Detection Reference indicates the protocol or message that is the target of header handling. Header Handling Reporting Endpoints are related information about target function nodes to which UPF sends results after traffic header handling processing, which can be at least one of SMF and NEF/AF. This includes a Notification Target Address and a Notification Correlation ID for the sending side to distinguish the same events.

Header Handling Direction indicates the direction of messages to which header handling is applied, which can be one or more of Uplink or Downlink. Header Handling Action is an action applied to header fields, which can be one of ‘Detect’, ‘Remove’, ‘Replace’, or ‘Insert’. Header Handling Condition indicates whether to apply only the first match of a specific header message or apply to every match.

Header Handling Reporting indicates whether to receive header handling processing results and also includes One-Time-Reporting indication and Reporting suggestion information to reduce signaling overhead. One-Time-Reporting indication is an indicator that requests reporting only for the first header handling action. Reporting suggestion information is reporting recommendation information needed to reduce signaling overhead by bundling multiple event results for the same Reporting Endpoint and sending them within a given time instead of sending all packet handling results of requested headers to the Reporting Endpoint for every packet.

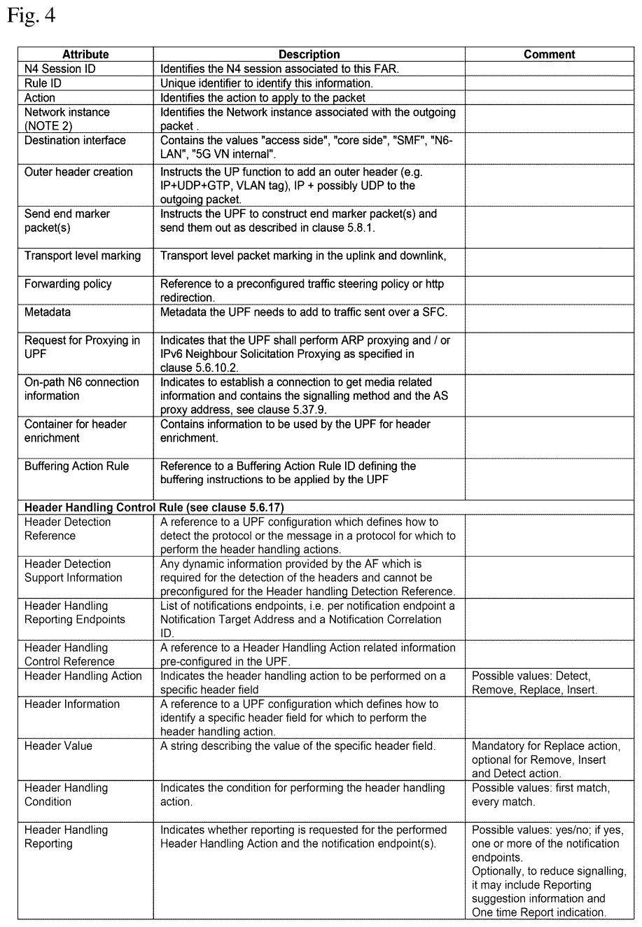

FIG. 4 is an N4 FAR (Forwarding Action Rule) containing a Header Handling Control Rule according to an embodiment of the present invention. The header handling control rule is newly added to the conventional FAR between SMF and UPF.

The header handling control rule generated by SMF is based on PCC Rules created by PCF and sent to SMF. Also, PCF's PCC Rule is based on information elements of the AF Request containing Header Handling Control Information shown in FIG. 3 that AF initially sent to NEF for user traffic header handling.

The detailed information elements of the header handling rule included in FAR are the same as described in FIG. 3. That is, information elements such as Header Detection Reference, Header Handling Reporting Endpoints, Header Handling Direction, Header Handling Action, Header Handling Condition, and Header Handling Reporting are included in the header handling control rule within N4 FAR. Through this, UPF can perform operations such as header detection, removal, replacement, and insertion on user traffic according to detailed header handling instructions received from SMF.

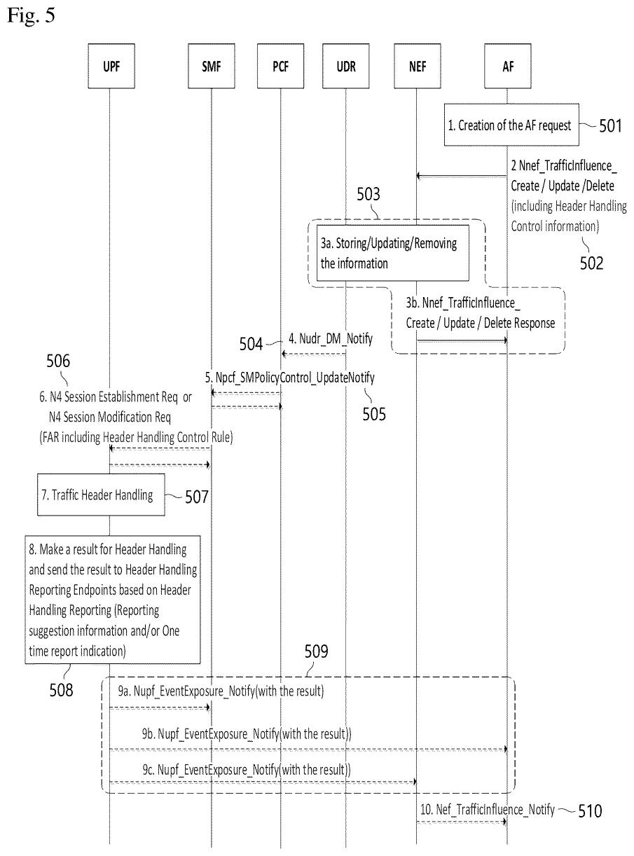

FIG. 5 is a signaling procedure for user traffic header handling according to an embodiment of the present invention. FIG. 5 updates the control procedure between AF and UPF for providing SFC functionality in conventional FIG. 2.

The procedures from Step 1 (501) to Step 5 (505) are the same as before, but for user traffic header handling, the header handling control information of FIG. 3 is additionally included in conventional information elements and transmitted from AF to SMF.

In Step 1 (501), AF generates an AF request for header handling. In Step 2 (502), AF sends a Nnef_TrafficInfluence_Create/Update/Delete request including Header Handling Control Information to NEF. In Steps 3a and 3b (503), NEF stores/updates/removes information in UDR, and NEF responds to AF. In Step 4 (504), UDR notifies PCF about AF requirement modifications previously subscribed by PCF. In Step 5 (505), PCF determines policy based on received information, creates PCC rules with this, and sends them to SMF through Npcf_SMPolicyControl_UpdateNotify.

Subsequently, SMF generates N4 FAR containing the header handling control rule of FIG. 4 and sends it to UPF through N4 Session Establishment Req/Rsp or N4 Session Modification Req/Rsp (Step 6 (506)).

In Step 7 (507), UPF processes user traffic header handling according to received rules. In Steps 8 (508) and 9 (509), UPF generates header handling processing results and sends event results to SMF and/or NEF/AF, which are Header Handling Reporting Endpoints included in header handling rules received from SMF.

At this time, if UPF has Header Handling Reporting information in header handling control rules received from SMF and includes Reporting suggestion information to reduce UPF load, UPF recognizes that it is delay tolerant and defers sending the event result transmission until the Reporting time window included in Reporting Suggestion Information instead of sending immediately upon event detection. Subsequently, UPF finds event result reports with the same Notification Target Address that have been deferred, bundles the event results together (Step 8 (508)), and sends them to SMF and/or NEF/AF through a single Nupf_EventExposure_Notify service operation (Steps 9a (509), 9b (509), 9c (509)). Also, if Header Handling Reporting information includes One Time Reporting Indication, only the result of the first execution of the corresponding event is sent (Steps 9a (509), 9b (509), 9c (509)).

Following Step 9c (509), in Step 10 (510), NEF notifies AF of results through Nef_TrafficInfluence_Notify.

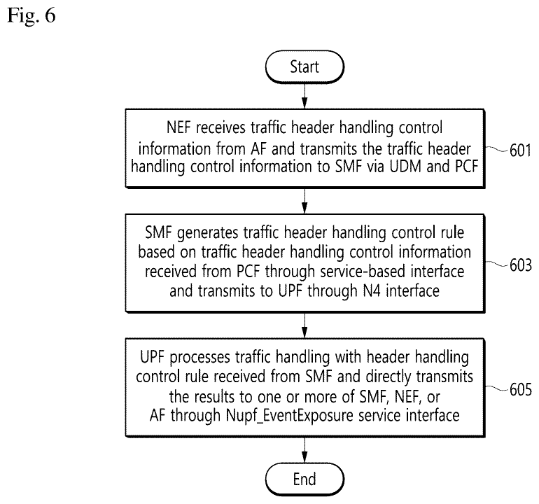

FIG. 6 is a flowchart of an event processing method for header handling of user traffic based on request from AF in a wireless communication system according to an embodiment of the present disclosure.

Referring to FIG. 6, in step 601, a Network Exposure Function (NEF) receives traffic header handling control information from an Application Function (AF) and transmits the traffic header handling control information to a Session Management Function (SMF) via Unified Data Management (UDM) and Policy Control Function (PCF). In step 603, SMF generates a traffic header handling control rule based on traffic header handling control information received from PCF through a Service Based Interface (SBI) and transmits it to a User Plane Function (UPF) through an N4 interface. In step 605, UPF processes user traffic handling with header handling control rules received from SMF and directly transmits the results to one or more of SMF, NEF, or AF through a Nupf_EventExposure service interface.

In one embodiment, the traffic header handling control information that AF sends to NEF in step 601 and the traffic header handling control rule that SMF generates in step 603 may include one or more of Header Handling Reporting information or Header Handling Reporting Endpoint information.

In another embodiment, the traffic header handling control information in step 601 may include one or more of Header Detection Reference, Header Handling Direction, and Header Handling Action.

In another embodiment, header handling reporting information may include one or more of Reporting indication, Reporting suggestion information, and One Time Reporting Indication for header handling processing results.

In another embodiment, Reporting suggestion information may indicate information that allows deferring multiple event result transmissions within a period up to the Reporting time window instead of sending event result transmission immediately upon event detection.

In another embodiment, Header Handling Reporting Endpoint includes Target Notification Address and Notification Correlation ID, and may be one or more of SMF or NEF/AF as target addresses that receive event results processed by UPF.

In another embodiment, the traffic header handling control rule generated by SMF in step 603 may be included in one of the FAR (Forwarding Action Rule), PDR (Packet Detection Rule), or URR (Usage Reporting Rule).

In another embodiment, the traffic header handling control rule generated by SMF in step 603 may be transmitted to UPF through N4 Session Establishment or N4 Session Modification messages.

In another embodiment, in step 605, UPF may transmit event results to Header Handling Reporting Endpoints based on Header Handling Reporting information in traffic header handling control rules received from SMF when reporting event results.

In another embodiment, header handling endpoints in step 605 may include one or more of SMF, NEF, or AF.

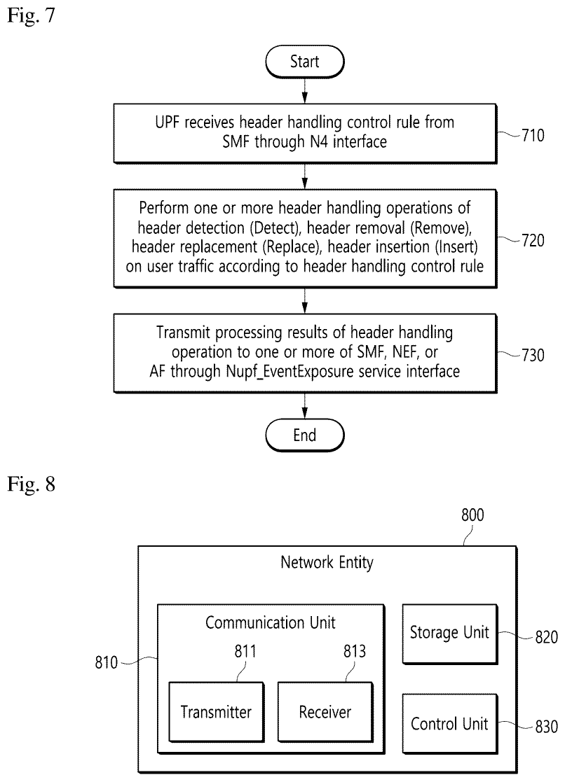

FIG. 7 is a flowchart of a method for performing header handling in UPF according to an embodiment of the present disclosure.

In step 710, UPF receives header handling control rules from Session Management Function (SMF) through an N4 interface. In step 720, UPF performs one or more header handling operations of header detection, header removal, header replacement, and header insertion on user traffic according to header handling control rules. In step 730, UPF transmits processing results of header handling operations to one or more of SMF, Network Exposure Function (NEF), or Application Function (AF) through a Nupf_EventExposure service interface.

In one embodiment, the header handling control rule that UPF receives in step 710 may be included in one of the FAR (Forwarding Action Rule), PDR (Packet Detection Rule), or URR (Usage Reporting Rule).

In another embodiment, the header handling control rule that UPF receives in step 710 may be received through N4 Session Establishment or N4 Session Modification messages.

In another embodiment, the process of UPF transmitting processing results in step 730 may transmit event results to Header Handling Reporting Endpoints based on Header Handling Reporting information included in header handling control rules.

In another embodiment, when including Reporting suggestion information, in step 730, instead of sending all handling results of requested packet headers to Reporting Endpoints for every packet, multiple event results for the same Reporting Endpoint can be bundled and sent within a given time period.

In another embodiment, when header handling reporting information includes One Time Reporting Indication, in step 730, UPF may send only the first execution result of header handling operations.

FIG. 8 illustrates the configuration of a network entity in a wireless communication system according to various embodiments of the present disclosure. The network entity of the present disclosure is a concept that includes network functions according to system implementation. Terms such as ‘unit’ and ‘device’ used below mean units that process at least one function or operation, which can be implemented as hardware, software, or a combination of hardware and software.

A network entity 800 according to various embodiments of the present disclosure may include a communication unit 810, a storage unit 820, and a control unit 830 that controls overall operations of the network entity 800.

The communication unit 810 transmits and receives signals with other network entities. Accordingly, all or part of the communication unit 810 may be referred to as a ‘transmitter 811’, ‘receiver 813’, or ‘transceiver 810’.

The storage unit 820 stores data such as basic programs, application programs, and configuration information for operation of the network entity 800. The storage unit 820 may be composed of volatile memory, non-volatile memory, or a combination of volatile and non-volatile memory. The storage unit 820 provides stored data according to requests from the control unit 830.

The control unit 830 controls overall operations of the network entity 800. For example, the control unit 830 transmits and receives signals through the communication unit 810. Additionally, the control unit 830 records and reads data in the storage unit 820. The control unit 830 may perform protocol stack functions required by communication standards. For this purpose, the control unit 830 may include circuits, application-specific circuits, at least one processor or microprocessor, or may be part of a processor. Additionally, part of the communication unit 810 and the control unit 830 may be referred to as a CP (communication processor).

The network entity 800 includes network nodes and may be any one of Application Function (AF), Network Exposure Function (NEF), Policy Control Function (PCF), Session Management Function (SMF), User Plane Function (UPF), Unified Data Repository (UDR), Data Network (DN), Radio Access Network (RAN), Access and Mobility Management Function (AMF), Authentication Server Function (AUSF), Unified Data Management (UDM), Network Slice Selection Function (NSSF), and Network Repository Function (NRF).

Methods according to embodiments described in the claims or specification of the present disclosure may be implemented in the form of hardware, software, or a combination of hardware and software.

When implemented in software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, magnetic cassettes. Alternatively, they may be stored in memory composed of some or all combinations thereof. Additionally, each constituent memory may be included in multiple numbers.

Additionally, programs may be stored in attachable storage devices that can be accessed through communication networks such as the Internet, Intranet, local area network (LAN), wide area network (WAN), or storage area network (SAN), or combinations thereof. Such storage devices may connect to devices performing embodiments of the present disclosure through external ports. Additionally, separate storage devices on communication networks may connect to devices performing embodiments of the present disclosure.

In the specific embodiments of the present disclosure described above, components included in the disclosure have been expressed in singular or plural forms according to presented specific embodiments. However, singular or plural expressions are appropriately selected for situations presented for convenience of explanation, and the present disclosure is not limited to singular or plural components. Components expressed in plural may be configured in singular, or components expressed in singular may be configured in plural.

Meanwhile, while specific embodiments have been described in the detailed description of the present disclosure, various modifications are possible within the scope of the present disclosure. Therefore, the scope of the present disclosure should not be limited to described embodiments but should be determined by the scope of claims described below as well as equivalents thereof.

What is claimed is:

1. An event processing method for header handling of user traffic based on application request in a wireless communication system, the method comprising:
a Network Exposure Function (NEF) receiving traffic header handling control information from an Application Function (AF) and transmitting the traffic header handling control information to a Session Management Function (SMF) via Unified Data Management (UDM) and a Policy Control Function (PCF);
the SMF generating a traffic header handling control rule based on the traffic header handling control information received from the PCF through a Service Based Interface (SBI) and transmitting the traffic header handling control rule to a User Plane Function (UPF) through an N4 interface; and
the UPF processing traffic handling with the header handling control rule received from the SMF and directly transmitting handling processing results to one or more of the SMF, the NEF, or the AF through a Nupf_EventExposure service interface.

2. The method of claim 1, wherein the traffic header handling control information and the traffic header handling control rule include one or more of Header Handling Reporting information or Header Handling Reporting Endpoint information.

3. The method of claim 2, wherein the header handling reporting information includes one or more of a Reporting indication for header handling processing results, Reporting suggestion information, or a One Time Reporting Indication.

4. The method of claim 3, wherein the Reporting suggestion information indicates information that allows deferring transmission of multiple event results within a period up to a Reporting time window instead of transmitting event results immediately upon event detection.

5. The method of claim 3, wherein the One Time Reporting Indication indicates a report request only for a first occurring event of header handling operations.

6. The method of claim 2, wherein the Header Handling Reporting Endpoint includes a Target Notification Address and a Notification Correlation ID, and is one or more of the SMF, the NEF, or the AF as target addresses that receive event results processed by the UPF.

7. The method of claim 1, wherein the traffic header handling control rule generated by the SMF is included in one of the Forwarding Action Rule (FAR), Packet Detection Rule (PDR), or Usage Reporting Rule (URR).

8. The method of claim 1, wherein the traffic header handling control rule generated by the SMF is transmitted to the UPF through an N4 Session Establishment or N4 Session Modification message.

9. The method of claim 1, wherein the UPF transmits event results to the SMF, the NEF, or the AF according to reporting information included in the header handling control rule.

10. The method of claim 1, wherein the traffic header handling control information includes one or more of Header Detection Reference, Header Handling Direction, or Header Handling Action.

11. An operation method of a User Plane Function (UPF) performing header handling in a wireless communication system, the method comprising:
receiving a header handling control rule from a Session Management Function (SMF) through an N4 interface;
performing one or more header handling operations of header detection, header removal, header replacement, and header insertion on user traffic according to the header handling control rule; and
transmitting processing results of the header handling operations to one or more of the SMF, a Network Exposure Function (NEF), or an Application Function (AF) through a Nupf_EventExposure service interface.

12. The method of claim 11, wherein the header handling control rule is included in one of the Forwarding Action Rule (FAR), Packet Detection Rule (PDR), or Usage Reporting Rule (URR).

13. The method of claim 11, wherein the header handling control rule is received through an N4 Session Establishment or N4 Session Modification message.

14. The method of claim 11, wherein transmitting the processing results comprises transmitting event results to the SMF, the NEF, or the AF based on reporting information included in the header handling control rule.

15. The method of claim 14, wherein when the header handling reporting information includes one or more of Reporting suggestion information or a One Time Reporting Indication, transmitting multiple event results bundled together according to the Reporting suggestion information or transmitting only a first execution result according to the One Time Reporting Indication.

16. Apparatus for a User Plane Function (UPF) performing header handling in a wireless communication system, the apparatus comprising:
a transceiver; and
a processor operatively connected to the transceiver,
wherein the processor is configured to:
receive a header handling control rule from a Session Management Function (SMF) through an N4 interface;
perform one or more header handling operations of header detection, header removal, header replacement, and header insertion on user traffic according to the header handling control rule; and
transmit processing results of the header handling operations to one or more of the SMF, a Network Exposure Function (NEF), or an Application Function (AF) through a Nupf_EventExposure service interface.

17. The apparatus of claim 16, wherein the header handling control rule is included in one or more of a Forwarding Action Rule (FAR), a Packet Detection Rule (PDR), or a Usage Reporting Rule (URR).

18. The apparatus of claim 16, wherein the header handling control rule is received through an N4 Session Establishment or N4 Session Modification message.

19. The apparatus of claim 16, wherein the processor is configured to transmit event results to the SMF, the NEF, and/or the AF based on reporting information included in the header handling control rule.

20. The apparatus of claim 19, wherein when the header handling reporting information includes one or more of Reporting suggestion information or a One Time Reporting Indication, the processor transmits multiple event results bundled together according to the Reporting suggestion information or transmits only a first execution result according to the One Time Reporting Indication.
